(19) United States
(12) Patent Application Publication
(10) Pub. No.: US 2018/0143693 A1
(43) Pub. Date: May 24, 2018

(54) VIRTUAL OBJECT MANIPULATION

(71) Applicants: David J. Calabrese, Bellevue, WA (US); Julia Schwarz, Redmond, WA (US); Yasaman Sheri, Seattle, WA (US); Daniel B. Witriol, Kirkland, WA (US)

(72) Inventors: David J. Calabrese, Bellevue, WA (US); Julia Schwarz, Redmond, WA (US); Yasaman Sheri, Seattle, WA (US); Daniel B. Witriol, Kirkland, WA (US)

(21) Appl. No.: 15/358,022

(22) Filed: Nov. 21, 2016

(51) Int. Cl. G06F 3/01; G06F 3/0484; G06K 9/00; G06K 9/66

(52) U.S. Cl. CPC G06F 3/017; G06F 3/04845; G06F 3/011; G06K 9/66; G06K 9/00355

(57) ABSTRACT

A method for moving a virtual object includes detecting a position of two input objects. A position of a centroid that is equidistant from the two input objects and located between the two input objects is dynamically calculated, such that a reference line running between the two input objects intersects the centroid. Upon detecting a movement of the two input objects, the movement is translated into a change in one or both of a position and an orientation of the virtual object. Movement of the centroid caused by movement of the two input objects causes movement of the virtual object in a direction corresponding to the movement of the centroid. Rotation of the reference line about the centroid caused by the movement of the two input objects causes rotation of the virtual object about its center in a direction corresponding to the rotation of the reference line.

### BACKGROUND

Virtual objects may be presented via a variety of portable and/or stationary display devices, including via head-mounted display devices (HMDs). Such devices can be used to provide augmented reality (AR) experiences and/or virtual reality (VR) experiences by presenting virtual imagery to a user. The virtual imagery may be moved, rotated, resized, and/or otherwise manipulated based on user input.

### BRIEF DESCRIPTION OF THE DRAWINGS

FIG. 1 schematically shows an example environment including a virtual object.

FIG. 2 illustrates an example method for moving a virtual object.

FIG. 3 schematically illustrates targeting of a virtual object for movement.

FIG. 4 schematically illustrates detecting a position of two input objects.

FIG. 5 schematically shows translation of a virtual object based on movement of two input objects.

FIG. 6 schematically shows rotation of a virtual object based on movement of two input objects.

FIG. 7 schematically shows resizing of a virtual object based on movement of two input objects.

FIG. 8 schematically shows translation of a detected movement by a machine learning classifier.

FIG. 9 schematically shows an example virtual reality computing device usable to present virtual imagery.

FIG. 10 schematically shows an example computing system.

### DETAILED DESCRIPTION

As indicated above, a variety of different computing systems may present virtual objects and other virtual imagery to users via suitable displays. Such virtual objects can be manipulated by users of the computing system. For example, by supplying a suitable input, a user may translate, rotate, and/or resize a virtual object. However, the actions needed to manipulate the virtual object may be difficult or counterintuitive, particularly in the case of multiple simultaneous manipulations (e.g., translation, rotation, and/or resizing).

Difficulties can be particularly evident when the virtual object is part of a virtual or at ted reality environment, in which the user wants/expects to handle the virtual object as though it were a physical object in the real world. Typical approaches to enabling manipulation require that only one type of manipulation be performed at a time. In other words, if the user wishes to both translate and rotate a virtual object, typically they must first translate the object and then switch to a different mode to perform the rotation. This sequential requirement creates a counter intuitive, unnatural user experience that departs from how objects are handled in the real world.

Accordingly, the present disclosure s directed to a technique that allows a user to change one or both of the position and orientation of a virtual object by moving two input objects, such as the user's hands. In some implementations, movement of the input objects may also cause a change in size of the virtual object. Notably, this technique allows for multiple independent categories of manipulations to be performed on the input object simultaneously, in response to a single movement of the two input objects that causes multiple categories of manipulation at once. In other words, the computing system may change each of the position, orientation, and size of the virtual object in response to a single movement of the user's hands. The virtual object manipulation techniques described herein therefore allow the user to precisely move a virtual object in a way that feels natural and intuitive, without requiring use of complicated controllers or multiple modes to perform simple manipulations.

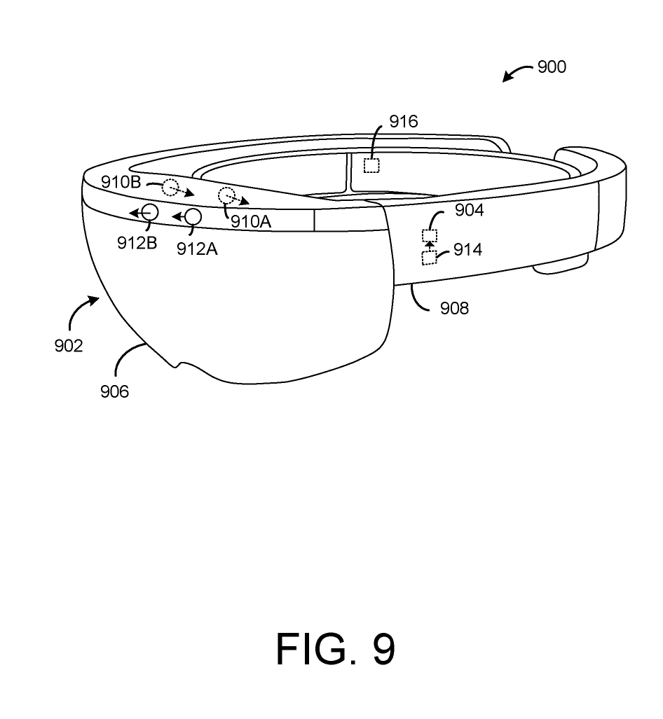

It will be appreciated that a virtual object may be presented by a variety of different computing systems in a number of different contexts. In the present disclosure, the description is primarily focused on virtual objects and other imagery presented as part of a virtual or augmented reality environment. In these examples, the environment is facilitated by a virtual reality computing device, such as that described below with reference to FIG. 9. The term “virtual reality computing device” is generally used herein to describe head-mounted display device (HMD) including one or more near-eye displays, though devices having other form factors may instead be used to view and manipulate virtual imagery. For example, virtual object manipulation as described herein can also be implemented with non-HMD screens, such as televisions, computer monitors, smartphone/tablet displays, laptop screens, and/or any other suitable display. Further, the virtual object manipulation techniques may be implemented by any computing system configured to present virtual objects and manipulate such virtual objects in response to user input.

For example, these techniques may be used to move a virtual object presented on a television or monitor as part of a video game, presented by a smartphone or tablet as part of a software application, presented on a computer display during creation of three-dimensional animations or computer-generated effects, and/or any other virtual objects presented in any other contexts.

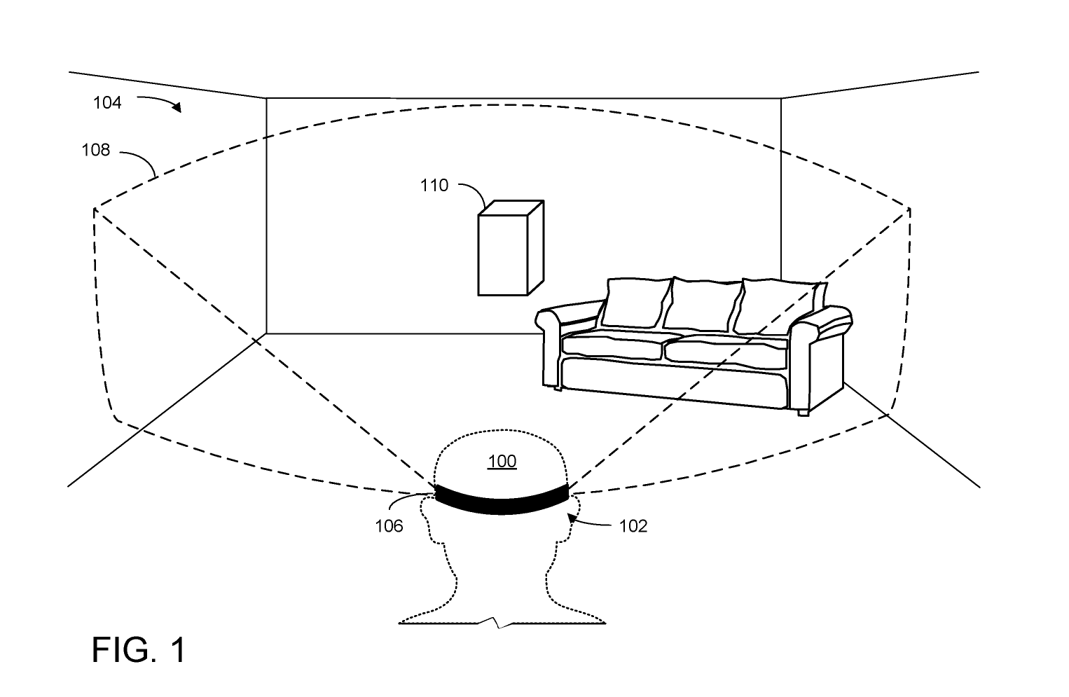

FIG. 1 schematically shows a user 100 wearing a virtual reality computing device 102 and viewing a surrounding environment 104. Virtual reality computing device 102 includes one or more near-eye displays 106 configured to present virtual imagery to eyes of the user. FIG. 1A also shows a field of view (FOV) 108 of the user, indicating the area of environment 104 visible to user 100 from the illustrated vantage point.

Virtual reality computing device 102 may be an augmented reality computing device that allows user 100 to directly view a real world environment through a partially transparent near-eye display. In other examples, the virtual reality computing device may be fully opaque and either present imagery of a real world environment as captured by a front-facing camera, or present a fully virtual surrounding environment. To avoid repetition, experiences provided by both implementations are referred to as “virtual reality” and the computing devices used to provide the augmented or opaque experiences are referred to as virtual reality computing devices. Further, it will be appreciated that regardless of whether a full virtual or augmented reality experience is implemented, FIG. 1 shows at least some virtual imagery that is only visible to a user of a virtual reality computing device.

Specifically, FIG. 1 shows a virtual object 110 taking the form of a rectangular box. Virtual reality computing device 102 may be configured to allow user 100 to translate, rotate, and/or resize the virtual object as desired. For example, the user may freely translate the virtual object in three dimensions, allowing for three degrees-of-freedom movement (3 DOF). The user may also rotate the virtual object to adjust its pitch, yaw, and/or roll, for a total of six degrees-of-freedom (6 DOF). Further, the user may selectively change the size of the object, by independently changing the dimensions of the object relative to each of the three axes (e.g., by making the object wider/thinner, longer/shorter, and/or taller/shorter), and/or uniformly changing the size of the object relative to all three dimensions. However, each of these different types of manipulation present different challenges, and can be difficult to disambiguate. An attempt to rotate virtual object can easily be interpreted as a resizing or movement operation, causing confusion for the user. This is why performing multiple types of manipulations on a virtual object typically requires use of complicated input schemes and/or frequent mode changes to switch between translation,rotation, and resizing.

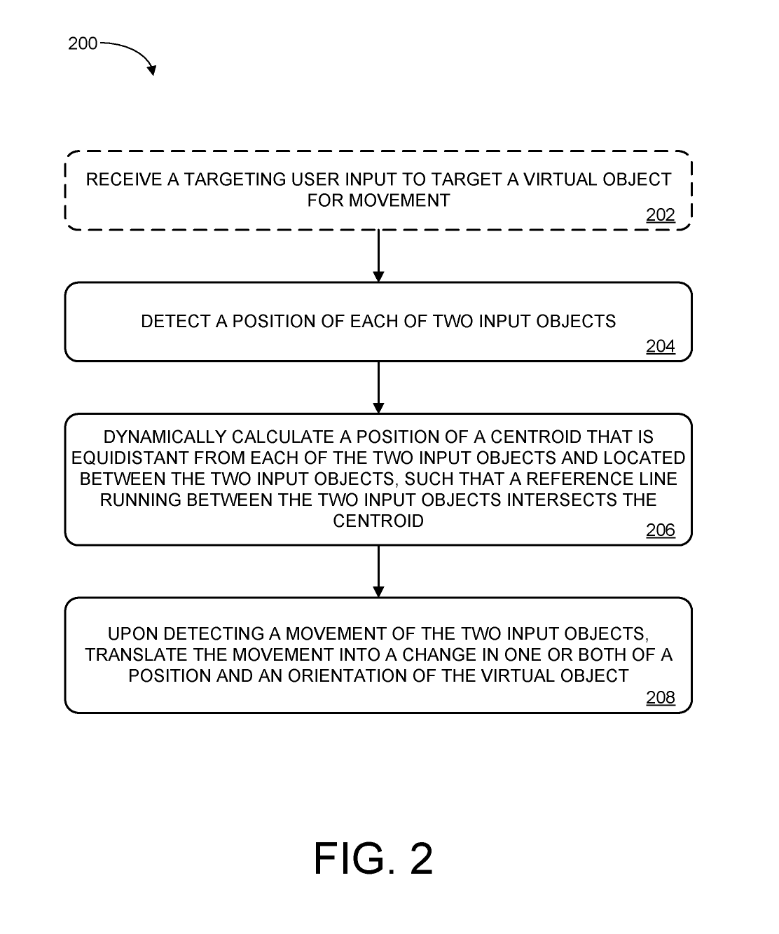

Accordingly, FIG. 2 illustrates an example method 200 for manipulating a virtual object. Method 200 allows the user to change one or both of a position and orientation of the virtual object by moving two input objects. Movement of the input objects may optionally allow the user to change the size of the object in addition to the position and the orientation. Notably, and in contrast to existing solutions, this method allows multiple different categories of manipulations to be applied to a virtual object at once, providing for a more intuitive and user-friendly experience.

At 202, method 200 optionally includes receiving a targeting user input to target a virtual object for movement. “Targeting” of a virtual object may involve simply selecting an entire virtual object that future user inputs cause it to be moved, rotated, and/or resized. In some implementations, the user may specifically target certain points on the virtual object (e.g., the sides or the corners), and this may affect how a given user input is applied to the object. A targeting input may take a variety of forms. For example, virtual reality computing device 302 may incorporate componentry for tracking a gaze of a user, and/or otherwise identify a target of the user's focus. A targeting input may then be performed by the user simply by looking at and/or focusing on a virtual object. Additionally, or alternatively, the virtual reality computing device may be configured to identify gestures performed by a wearer. For example, the wearer may perform a “pinch” gesture with one or both hands, point at the virtual object, reach out and “touch” the virtual object, use one or more input objects (e.g., the user's hands) to select a virtual object with a virtual cursor, etc. In some implementations, a user may target a virtual object using spoken commands, by manipulating buttons on a physical controller and/or a control interface that is combined with the virtual reality computing device, and/or perform any other suitable gestures/commands in order to target a virtual object for movement.

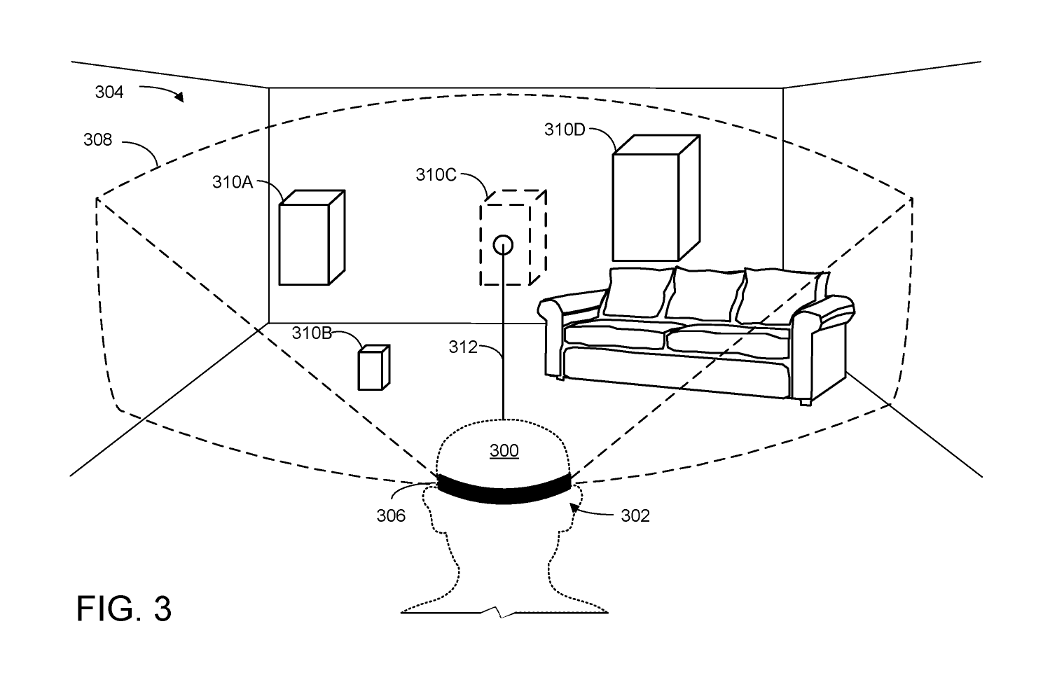

Targeting of a virtual object for movement is illustrated in FIG. 3, which shows a user 300 using a virtual reality computing device 302 to view a surrounding environment 304 via a near-eye display 306. FIG. 3 also shows a field of view (FOV) 308 of the user, indicating the area of environment 304 visible to user 300 from the illustrated vantage point.

As shown, several virtual objects 310A-310D are visible within FOV 308. User 300 has performed a targeting input 312 to target virtual object 310C for movement. In some implemenations, a user may target multiple virtual objects at the same time, and therefore move several virtual objects simultaneously. As described above, a targeting input performed by a user may take a variety of suitable forms. The targeting input is illustrated in FIG. 3 by the line that runs from user 300 to virtual object 310C and terminates in a circle. As a result of the targeting input, virtual object 310C has been targeted for movement. This is indicated in FIG. 3 by the dashed outline of virtual object 310C, while the other illustrated virtual objects have solid outlines. In some implementations, an appearance of a virtual object may change upon being targeted for movement, though in other implementations no such change may occur. An appearance of a targeted virtual object may change in a variety of ways.

In some cases, each input object may target a different particular point on the virtual object, and this may affect how movements of the input objects are translated into manipulations of the virtual object. For example, when the user desires to “stretch” the vertical object by increasing its horizontal size, the user may target particular points on the sides of the virtual object. Similarly, if the user desires to rotate the virtual object about a horizontal or vertical axis, then the user may target points on the vertical (e.g., “top and bottom”) or horizontal (e.g., “left and right”) sides of the virtual object respectively.

Returning to FIG. 2, at 204, method 200 includes detecting a position of each of two input objects. For example, the virtual reality computing; device may detect three-dimensional coordinates for each input object (e.g., X, Y, and Z coordinates). In some implementations, the virtual reality computing device may detect additional coordinates for each input object, such as its angle/attitude relative to one or more axes, for example.

As indicated above, input objects may frequently take the form of hands of a user of a virtual reality computing device. Such a device may, for example, include one or more cameras (e.g., visible light cameras and/or infrared depth cameras) usable for tracking a position of the user's hands, and interpreting movement of the hands as gestures. Additionally, or alternatively, the virtual reality computing device may communicate with one or more external cameras located in a surrounding environment, and such cameras may be used to detect positions of input objects in addition to or instead of cameras built into the virtual reality computing device.

It will be appreciated that input objects may take forms other than a user's hands. For example, input objects may take the form of physical motion controllers moved by a user. The positions of these motion controllers may also be detected by one or more cameras associated with the virtual reality computing device, and/or the controllers themselves may track their own positions (via built-in accelerometers, gyroscopes, magnetometers, and/or other suitable motion sensors), and report their movements to the virtual reality computing device via a wireless connection (such as Bluetooth, near communication, WiFi, etc.). As another example, the two input objects may be the index fingers of the user, and the virtual reality computing device may be configured to track the positions of the index fingers while ignoring the rest of the user's hands, or track movements of the user's other fingers for other purposes. In general, a virtual reality computing device may be configured to detect the positions of any suitable pair of objects, including asymmetrical pairs (e.g., one tracked object is a user's hand while another is a physical controller). As will be described below, a detected movement of two input objects may be translated into a change in one or more of position, orientation and/or size of a virtual object.

At 206, method 200 includes dynamically calculating a position of a centroid that is equidistant from each of the two input objects and located between the input objects. In other words, the centroid may be positioned such that a reference line running between the two input objects intersects the centroid. For example, the virtual reality computing device may calculate a three-dimensional position that is exactly between each input object (i.e., equidistant from each input object), and this position may be dynamically updated as the input objects move.

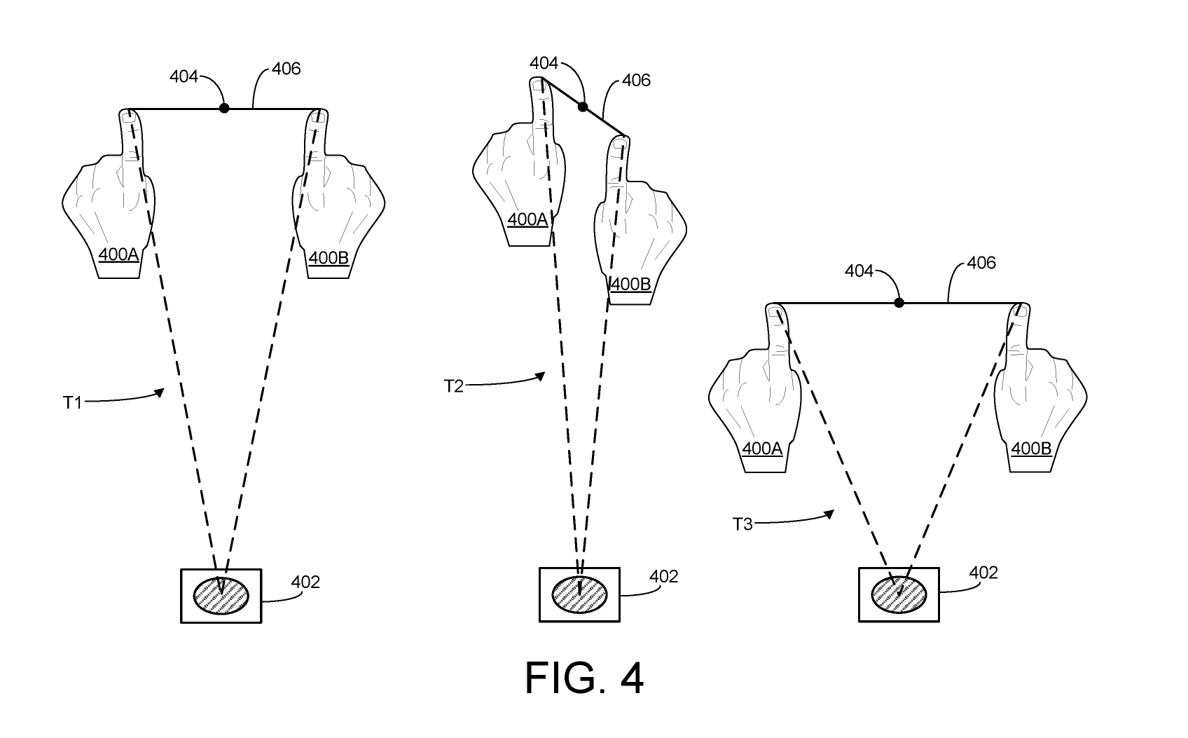

This is schematically illustrated in FIG. 4, which shows movement of two different input objects 400 over time. As shown, input objects 400A and 400B are hands of a user of a virtual reality computing device, though other input objects may instead be used, as described above. The positions of the input objects are detected via, an input subsystem 402, which may be a component of a virtual reality computing device not shown in FIG. 4. Dashed lines extending from the input subsystem to each input object are intended to illustrate that the position of each input object is tracked independently. As described above, the input subsystem may include any collection of components either built into the virtual reality computing device and/or usable with the virtual reality computing device. For example, the input subsystem may include one or more cameras, microphones (e.g., for detecting ultrasonic frequencies used to detect positions of the input objects), communications interfaces (e.g., for receiving position information from physical motion controllers and/or other external sensors), and/or other components usable for tracking positions of input objects.

As shown in FIG. 4, a centroid 404 is located between the pair of input objects 400. The centroid is equidistant from each input object. A reference line 406 runs between the two input objects and intersects the centroid. Notably, the position of the centroid, and therefore the position and angle of the reference line, is calculated dynamically as the input objects move. This is shown in FIG. 4. Specifically, at T1, the input objects 400, centroid 404, and reference line 406 are occupying initial positions. Between T1 and T2, the input objects move closer together while input object 400A moves slightly forward and input object 400B moves slightly backwards. Accordingly, the virtual reality computing device has dynamically recalculated the position of centroid 400 so as to remain between and equidistant from each input object. The position and angle of the reference line has similarly changed. Further movement of the input objects takes place between T2 and T3, in which the input objects move closer to input subsystem 402 and further away from each other. The positions of the centroid and reference line are correspondingly updated again.

It will be appreciated that centroids and reference lines described herein and illustrated in the figures are generally used as reference points for the sake of determining the relative positions and movements of two input objects. Accordingly, centroids and reference lines will generally not be visible to the user of the virtual reality computing device, and are shown here simply as visual aids.

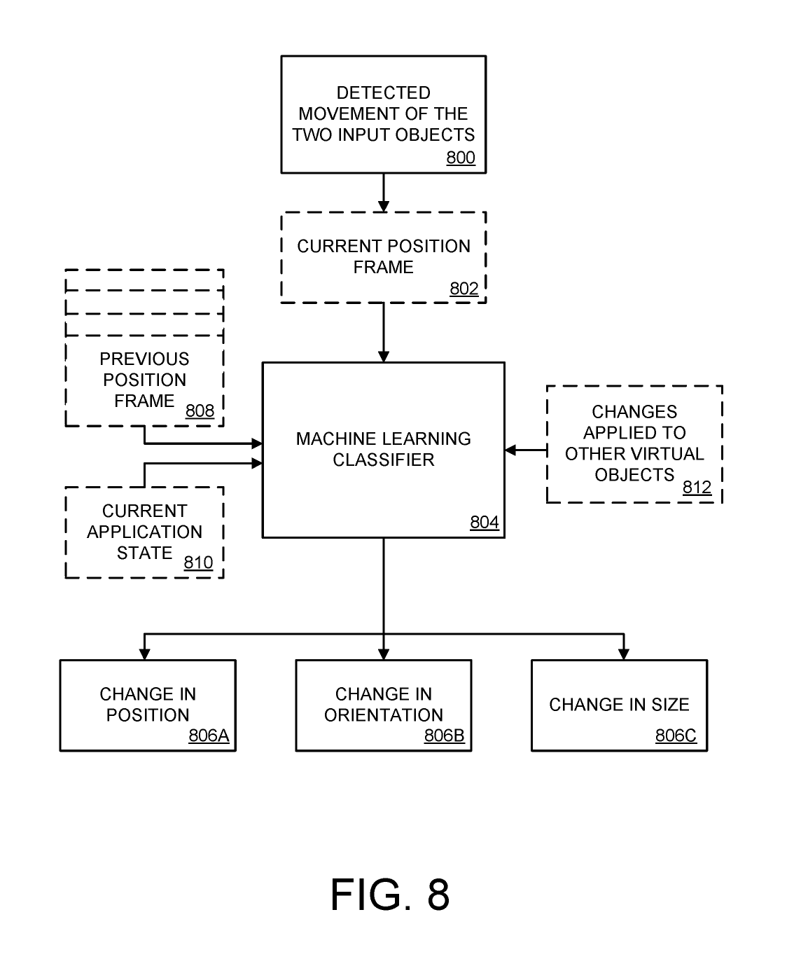

Returning to FIG. 2, at 208, method 200 includes, upon detecting movement of the two input objects, translating the movement into a change in one or both of a position and an orientation of the virtual object. In some implementations, the detected movement may additionally/alternatively be translated into a change in size of the virtual object. The detected motion may be translated into one or more different types of manipulations of the virtual object by a machine learning classifier, as will be described below with respect to FIG. 8.

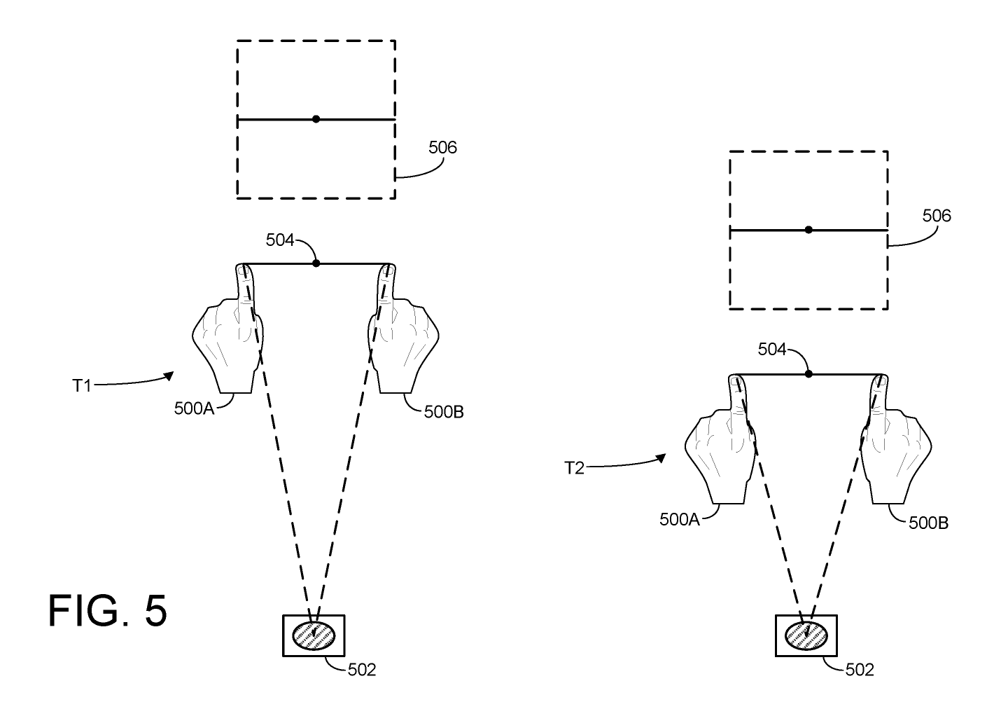

Changing a position of a virtual object in response to movement of two input objects is schematically illustrated in FIG. 5. Specifically, FIG. 5 shows two input objects 500A and 500B, the positions of which are being tracked by an input subsystem 502. A virtual reality computing device associated with the input subsystem is dynamically calculating the position of a centroid 504 as the input objects move. FIG. 5 also shows a virtual object 506 taking the form of a simple square.

At T1, each of the input objects, as well as the centroid and virtual object, are occupying initial positions relative to the input subsystem. Between T1 and T2, both of the input objects move closer to the input subsystem, though the distance and angle between the objects does not change. This causes corresponding movement of the centroid toward the input subsystem. The virtual reality computing device maybe configured to, upon movement of the centroid caused by movement of the two input objects, move the virtual object in a direction corresponding to the movement of the centroid. Accordingly, virtual object 506 has also moved closer to the input subsystem (i.e., it moved in the same direction as the centroid).

Though FIG. 5 only shows movement of the virtual object in a single dimension, it will be appreciated that movement of the centroid through three-dimensional space may cause corresponding movement of the virtual object through any or all of the three dimensions. For example, the user may move the two input objects along a path that has components in all three dimensions, causing the virtual object to follow a similar path.

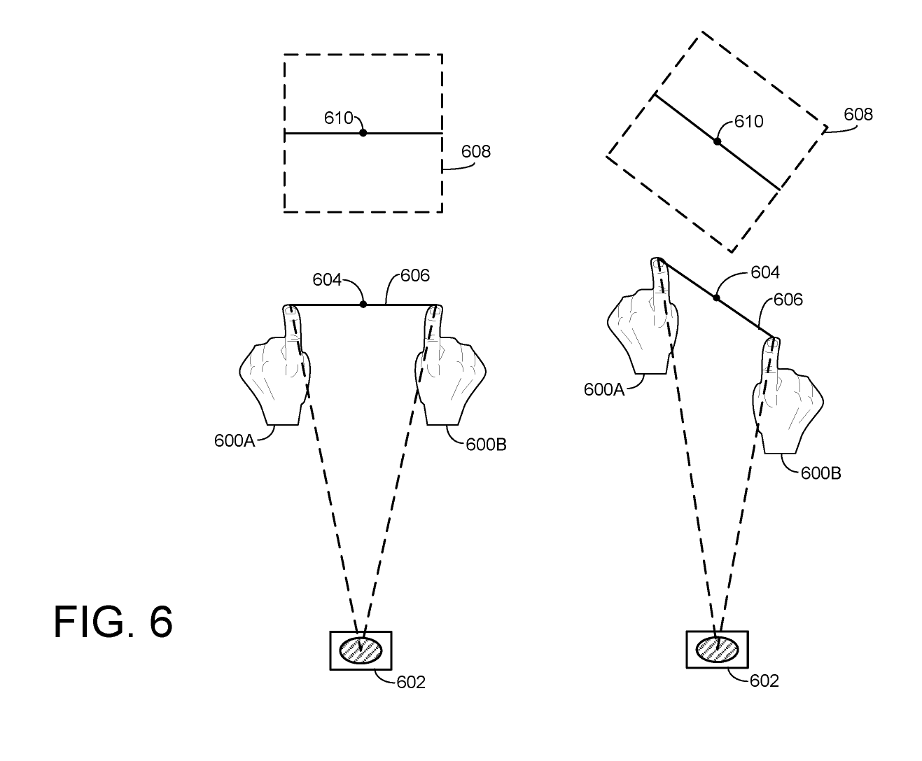

A virtual reality computing device may also be configured to change an orientation of a virtual object in response to movement of two input objects. Specifically, the virtual reality computing device may, upon rotation of the reference line about the centroid, rotate the virtual object about its center in a direction corresponding to the rotation of the refer line. This is schematically illustrated in FIG. 6, which again shows two input objects 600A and 600B, the positions which are being tracked by an input subsystem 602 associated with a virtual reality computing device. The virtual reality computing device is dynamically calculating the position of a centroid 604 located between the two input objects, such that a reference line 606 running between the two input objects intersects the centroid. FIG. 6 also shows a virtual object 608 having a center point 610.

Between T1 and T2, the positions of the two input objects move such that the three-dimensional position of the centroid does not change, and the input objects are the same distance away from each other in terms of linear distance, though the reference line has partially rotated relative to the centroid. Accordingly, virtual object 608 has also rotated in the same direction as reference line 606.

It will be appreciated that, while FIG. 6 only shows rotation of the virtual object about a single axis, rotation of the reference line about the centroid through any rotational axes may cause corresponding rotation of the virtual object. For example, the reference line may rotate about the centroid relative to one or more of the three dimensions (i.e., changing a pitch, yaw, and/or roll of the reference line), and this may cause rotation of the virtual object in a similar manner.

As indicated above, movement of the input objects may additionally or alternatively result in a change in size of the input object. Specifically, the virtual reality computing device may, upon the distance between the centroid and each input object changing as a result of movement of the two input objects, resize the virtual object. Resizing of the virtual object may only occur if the distance between each input object and the centroid (as indicated by the total length of the reference line) changes in terms of linear distance. Otherwise, rotation of the reference line that causes a component of the length of the reference line in one dimension to decrease and a component in a different dimension to increase could have undesirable effects on the size of the virtual object.

However, assuming that the length of the reference line in terms of linear distance does change, then the dimensions) of the virtual object to which the change in size are applied may depend on how components of the length of the reference line change in different dimensions. For example, increase in distance between the two input objects and the centroid along a horizontal axis may cause an increase in size of the virtual object along the horizontal axis. Similarly, an increase in distance between the two input objects and the centroid along a vertical axis perpendicular to the horizontal axis may cause an increase in size of the virtual object along the vertical axis. It will be appreciated that a similar change in the length of the reference line relative to a third axis perpendicular to both the horizontal and vertical axes may cause a corresponding change in size of the virtual object relative to that dimension. A decrease in the length of the reference line along any of the three axes may accordingly cause a decrease in size of the virtual object relative to the affected axes.

In some implementations, the manner in which a virtual object is resited may depend on which points on the virtual object the user has targeted. For example, if the user wishes to increase the size of the virtual object in the horizontal dimension (i.e., stretch the object horizontally), then the user may target particular points on each side of the virtual object, and move the two input objects away from each other in the horizontal dimension. Similarly, the user may increase the vertical size of the virtual object by targeting points on the top and bottom of the virtual object, and moving the two input objects away from each other in the vertical dimension. In some cases, if the user targets points in the corners of the virtual object, then the user may adjust the size of the virtual object along multiple dimensions simultaneously. Resizing of the virtual object may in some cases be restricted to one particular axis or set of axes at a time and this may depend on the points of the virtual object targeted by the user. Otherwise, complex resizing operations could be interpreted as rotation operations, and vice versa.

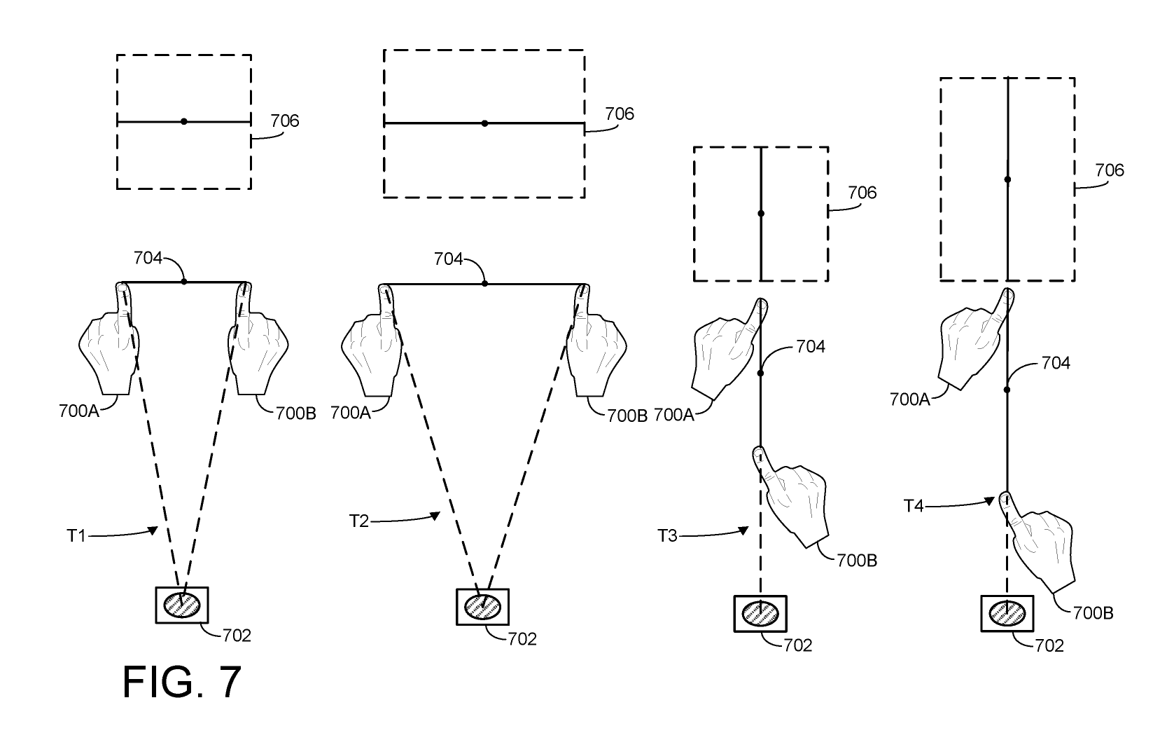

Resizing of a virtual object as described above is schematically illustrated in FIG. 7. Specifically, FIG. 7 shows two input objects 700A and 700B. The positions of which are being tracked by an input subsystem 702 associated with a virtual reality computing device. The virtual reality computing device is dynamically calculating the position of a centroid 704 that occupies a position that is a finite distance a a each input object. A change in the distance between the centroid and each input object (i.e., a change in the length of the reference line in terms of linear distance) may result in resizing of a virtual object, such as virtual object 706 shown in FIG. 7.

Specifically, between T1 and T2, the user moves the input objects away from each other along a horizontal axis, such that the distance between each input object and the centroid increases. Accordingly, the size of virtual object 706 along the horizontal axis increases. In other words, the virtual object is horizontally “stretched.” In some cases, this only be possible when the user has targeted particular points on the horizontal sides of the virtual object. Similarly, between T3 and T4, the distance between each input object and the centroid has increased along the vertical axis, resulting in a vertical stretching of the virtual object. As shown, at times T1 and T2, the user is targeting points on the horizontal “left and right” of the virtual object, as indicated by the horizontal line intersecting the center of virtual object 706. Similarly, at times T3 and T4, the user is targeting points on the vertical “top and bottom” of the virtual object. As described above, targeting of the object on its diagonal corners may allow the user to change the size of the virtual object relative to multiple dimensions at once.

It will be appreciated that, while the above categories of manipulations that can be applied to a virtual object changing its position, orientation, and size) are described and illustrated separately, in some cases a single integrated movement of the input objects may cause all three manipulations simultaneously. For example, if a user moves the input objects in such a way that the centroid moves, the angle of the reference line changes, and the distance between each input object and the centroid changes, then the position, orientation, and size of the virtual object may each be changed at once. This presents notable improvements over existing solutions that require specialized hardware, complicated input schemes, and/or frequent mode switches. In particular, the manner in which a particular movement of the input objects is interpreted (e.g., identifying movement of the centroid, rotation of the reference line, and/or a change in distance between the centroid and each input object) allows each different type of manipulation to be consistently disambiguated, allowing the user to perform any of the different categories of manipulation simultaneously, and providing for an intuitive experience.

In some implementations, movement of the centroid, rotation of the reference line, and/or a change in distance between the input objects and centroid may cause one or more types of manipulation of the virtual object that have the same magnitude as the movement of the input objects. In other words, if the centroid moves by 20 centimeters, then the virtual object may also move exactly 20 centimeters. However, in other implementations, a scaling algorithm may be applied during translation of the detected movement such that manipulation of the virtual object is either more or less pronounced than the instigating movement of the input objects. In other words, movement of the centroid by 20 centimeters may cause movement of the virtual object by 1 meter, or only 5 centimeters. The user may selectively change the magnitude and direction of the scaling applied to the detected movements, in order to increase or decrease the magnitude of the manipulations applied to the virtual object. In other words, the user may use a “fine control” setting to cause relatively large movements of the input objects to result in relatively small changes in position, orientation, and/or size of the virtual object. Other settings may cause smaller movements of the input objects to be translated into much more prominent manipulations of the virtual object.

In some cases, different types of manipulation of the virtual object (i.e., a change in one or more of the position orientation, and/or size) may only occur upon movement of the two input objects exceeding a threshold distance. For example, it may be difficult for the user to hold his or her hands in the exact same position relative to each other and to the user, though the user may not desire that the position, orientation, and/or size of the object change. Accordingly, the virtual reality computing device may be configured to disregard movements of the input objects within a predetermined “dead zone,” such that negligible movements of the input objects do not cause undesirable types of manipulation. In some cases, each independent category of manipulation of the virtual object may have its own independent dead zone. For example, the user may desire to move the virtual object, and accordingly move his hands in such a way that movement of the centroid extends beyond the “movement” dead zone. However, during this motion, the user may inadvertently alter the angle of the reference line. If this rotation is not sufficient to exceed a “rotation” dead zone, then rotation of the virtual object may not occur.

As described above, a detected movement of the two input objects is translated into a change in one or more of position, orientation, and size of the virtual object by the virtual reality computing device. In some implementations, this translation may be done by a machine learning classifier that predicts, for a given movement of the input objects, a desired type and magnitude of manipulation of the virtual object (e.g., movement of a certain distance, rotation of a certain number of degrees).

This may be used in addition to or as an alternative to a “dead zone” as described above, so as to further disambiguate a user's intended gestures from unintended or negligible movements of the input objects.

Further, it will be appreciated that while the present disclosure describes using a machine learning classifier to translate a detected movement, other techniques may additionally or alternatively be used. Though a machine learning classifier is provided as an example, particularly with regards to FIG. 8, a variety of potential recognition techniques could be used to translate a detected movement of two input objects into manipulation of the virtual object. For example, such translation could be performed by an ad hoc recognizer.

Use of a machine learning classifier to translate a detected movement of two input objects is schematically illustrated in FIG. 8. Specifically, FIG. 8 shows a detected movement 800 of two input objects. Input objects may take a variety of forms and move in a variety of ways, as described above. Further, the detected movement may occur relative to three directional axes, and cause any or all of a movement of a centroid, rotation of a reference line, and change in a distance between each input object and the centroid.

In some cases, for each of a series of time frames, a virtual reality computing device may record a position frame describing the positions of each input object, such as position frame 802 shown in FIG. 8. A “time frame” as described herein may have any suitable granularity. For example, the virtual reality computing device may track 10 time frames per second, 100 time frames per second, 1000 time frames per second, etc. In general, it is desirable that a time frame reflect a length of time that is short enough to allow movement of a virtual object to appear fluid and continuous from the perspective of the user, without consuming undue processing resources in the virtual reality computing device.

A position frame may contain a variety of suitable information. For example, each position frame may indicate a three-dimensional position of each input object according to a predetermined coordinate system. A position frame may also include a three-dimensional position of a centroid, a current angle formed by a reference line relative to three dimensional axes, and a distance between each input object and the centroid. Because position frame 802 is “current” position frame, it includes position information for each input object during a most recently recorded time frame.

The detected movement 800, and optionally the current position frame 802, may be provided to a machine learning classifier 804. The machine learning classifier may be configured to, for a given input (i.e., a detected movement of the input objects), output a change 806 in one or more of the position (806A), orientation (806B), and size (806C) of the virtual object. This may be done according to a variety of factors, as will be described below. As indicated above, other recognition techniques could be used in addition to or instead of a machine learning classifier, and such techniques may rely on the same or different information when translating movement of the input objects.

In some cases, a machine learning classifier may be configured to output a probability of user intent for each of three types of manipulation described herein. For example, for a detected movement of the input objects, the machine learning classifier may output that there is an 80% chance the user is attempting to move the virtual object, a 15% chance the user is attempting to rotate, and a 5% chance that the user is trying to resize. In some cases, the machine learning classifier ay simply apply the type of manipulation with the highest probability (in this case, movement). However, in other cases, the machine learning classifier may be configured to blend the probabilities and apply multiple types of manipulation to the virtual object at once. In the example given above, this would cause significant movement of the virtual object, slight rotation, and negligible resizing.

It will be appreciated that a variety of suitable techniques may be used to produce a machine learning classifier usable to translate detected movement of two input objects. The machine learning classifier may be trained on a variety of suitable inputs, and optionally include a feedback mechanism for dynamically learning from inputs that the user provides. For example, the user may naturally, during use of the virtual reality computing device, provide feedback usable to retrain the machine learning classifier to more accurately predict the user's intention. This may occur when, for example, the machine learning classifier predicts and applies a type of manipulation based on the detected movement that the user did not intend, and the user provides additional input in order to correct the error.

As indicated above, a variety of types of information input to the machine learning classifier, and considered when translating a detected movement into one or more types of manipulation of the virtual object. For example, the machine learning classifier may optionally receive a plurality of previous position frames 808. Each previous position frame may correspond to a previously recorded time frame, and include the same information described above with respect to current. position frame 802. Specifically, each previous position frame may include a three-dimensional position of each input object and the centroid, an angle of the reference line, and a distance between the centroid and the two input objects. It will be appreciated that any suitable number of previously recorded position frames may be provided to the machine learning classifier.

The machine learning classifier may also optionally receive a current application state 810 of a running software application that is rendering and/or facilitating movement of the virtual object. The current application state may take a variety of suitable forms, though in general may include any information provided by the application that is relevant to determining how the user is attempting to manipulate the virtual object. For example, the current application state may indicate that the user has been instructed to rotate the virtual object in a particular manner. Accordingly, the predicted likelihood that the user is attempting to rotate the virtual object in the described manner may be boosted by the machine learning classifier. Other example application states may include a current mode of the application, a current tool selected by the user, an environment in which the virtual object is being presented, etc.

The machine learning classifier also may optionally receive an indication of changes 812 in one or more of position, orientation, or size recently applied to one or more other virtual objects. For example, if the user has previously rotated five other virtual objects in a particular direction, then the machine learning classifier may predict that the user will rotate the currently targeted virtual object in a similar manner.

It will be appreciated that the above-described information that may be provided to the machine learning classifier is only intended to supplement the position information specified by the detected movement of the two input objects. In general, the machine learning classifier will not translate a detected movement into one or more types of manipulation that are wholly different from the detected movement, even if the detected movement seems inconsistent with predictions drawn from the previous position frames, current application state, and/or changes applied to other virtual objects.

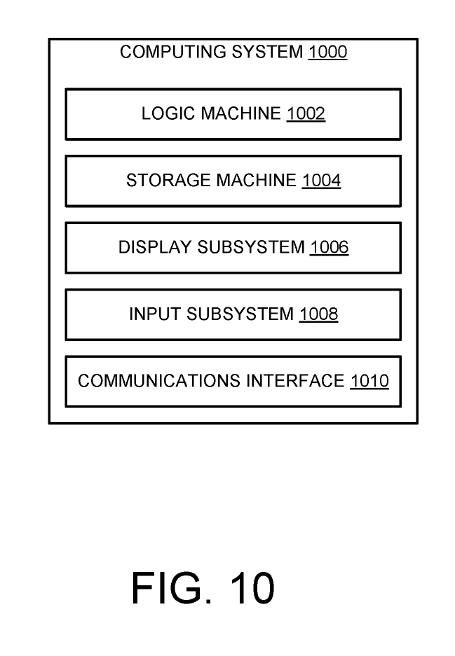

FIG. 9 shows aspects of an example virtual-reality computing system 900 including a near-eye display 902. The virtual-reality computing system 900 is a non-limiting example of the virtual-reality computing device 102 shown in FIG. 1 and virtual reality computing device 302 shown in FIG. 3. Virtual reality computing system 900 may include and/or be usable with input subsystems shown in FIGS. 4-7. Virtual reality computing device may be implemented as the computing system 1000 shown in FIG. 10.

The virtual-reality computing system 900 may be configured to present any suitable type of virtual-reality experience. In sonic implementations, the virtual-reality experience includes a totally virtual experience in which the near-eye display 902 is opaque, such that the wearer is completely absorbed in the virtual-reality imagery provided via the near-eye display 902.

In some implementations, the virtual-reality experience includes an augmented-reality experience in which the near-eye display 902 is wholly or partially transparent from the perspective of the wearer, to give the wearer a clear view of a surrounding physical space. In such a configuration, the near-eye display 902 is configured to direct display light to the user's eye(s) so that the user will see augmented-reality objects that are not actually present in the physical space. In other words, the near-eye display 902 may direct display light to the user's eye(s) while light from the physical space passes through the near-eye display 902 to the user's eye(s). As such, the user's eye(s) simultaneously receive light from the physical environment and display light.

In such augmented-reality implementations, the virtual-reality computing system 900 may be configured to visually present augmented-reality objects that appear body-locked and/or world-locked. A body-locked augmented-reality object may appear to move along with a perspective of the user as a pose (e.g., six degrees of freedom (DOF): x, y, z, yaw, pitch, roll) of the virtual-reality computing system 900 changes. As such, a body-locked, augmented-reality object may appear to occupy the same portion of the near-eye display 902 and appear to be at the same distance from the user, even as the user moves in the physical space. Alternatively, a world-locked, augmented-reality object may appear to remain in a fixed location in the physical space, even as the pose of the virtual-reality computing system 900 changes. When the virtual-reality computing system 900 visually presents world-locked, augmented-reality objects, such a virtual-reality experience may be referred to as a mixed-reality experience.

In some implementations, the opacity of the near-eye display 902 is controllable dynamically via a dimming filter. A substantially see-through display, accordingly, may be switched to full opacity for a fully immersive virtual-reality experience.

The virtual-reality computing system 900 may take any other suitable form in which a transparent, semi-transparent, and/or non-transparent display is supported in front of a viewer's eye(s). Further, implementations described here may be used with any other suitable computing device, including but not limited to wearable computing devices, mobile computing devices, laptop computers, desktop computers, smart phones, tablet computers, etc.

Any suitable mechanism may be used to display images via the near-eye display 902. For example, the near-eye display 902 may include image-producing elements located within lenses 906. As another example, the near-eye display 902 may include a display device, such as a liquid crystal on silicon (LCOS) device or OLED microdisplay located within a frame 908. In this example, the lenses 906 may serve as, or otherwise include, a light guide for delivering light from the display device to the eyes of a wearer. Additionally or alternatively, the near-eye display 902 may present left-eye and right-eye virtual-reality images via respective left-eye and right-eye displays.

The virtual-reality computing system 900 includes an on-board computer 904 configured to perform various operations related to receiving user input (e.g., gesture recognition, eye gaze detection), visual presentation of virtual-reality images on the near-eye display 902, and other operations described herein. In some implementations, some to all of the computing functions described above, may be performed off board.

The virtual-reality computing system 900 may include various sensors and related systems to provide information to the on-board computer 904. Such sensors may include, but are not limited to, one or more inward facing image sensors 910A and 910B, one or more outward facing image sensors 912A and 912B, an inertial measurement unit (IMU) 914, and one or more microphones 916. The one or more inward facing image sensors 910A, 910B may be configured to acquire gaze tracking information from a wearer's eyes (e.g., sensor 910A may acquire image data for one of the wearer's eye and sensor 910B may acquire image data for the other of the wearer's).

The on-board computer 904 may be configured to determine gaze directions of each of a wearer's eyes in any suitable manner based on the information received from the image sensors 910A, 910B. The one or more inward facing image sensors 910A, 910B, and the on-board computer 904 may collectively represent a gaze detection machine configured to determine a wearer's gaze target on the near-eye display 902. In other implementations, a different type of gaze detector/sensor may be employed to measure one or more gaze parameters of the user eyes. Examples of gaze parameters measured by one or more gaze sensors that may be used by the on-board computer 904 to determine an eye gaze sample may include an eye gaze direction, head orientation, eye gaze velocity, eye gaze acceleration change in angle of eye gaze direction, and/or any other suitable tracking information. In some implementations, eye gaze tracking may be recorded independently for both eyes.

The one or more outward facing image sensors 912A, 912B may be configured to measure physical environment attributes of a physical space. In one example, a sensor 912A may include a visible-light camera configured to collect a visible-light image of a physical space. Further, the image sensor 912B may include a depth camera configured to collect a depth image of a physical space. More particularly, in one example, the depth camera is an infrared time-of-flight depth camera. In another example, the depth camera is an infrared structured light depth camera.

Data from the outward facing image sensors 912A, 912B may be used by the on board computer 904 to detect movements, such as gesture-based inputs or other movements performed by a wearer or by a person or physical object in the physical space. In one example, data from the outward facing image sensors 912A, 912B may be used to detect a user input performed by the wearer of the virtual-reality computing system 900, such as a gesture. Data from the outward facing image sensors 912A, 912B may be used by the on-board computer 904 to determine direction/location and orientation data (e.g., from imaging environmental features) that enables position/motion tracking of the virtual-reality computing system 900 in the real-world environment. In some implementations, data from the outward facing image sensors 912A, 912B may be used by the on-board computer 904 to construct still images and/or video images of the surrounding environment from the perspective of the virtual-reality computing system 900.

The IMU 914 may be configured to provide position and/or orientation data of the virtual-reality computing system 900 to the on-board computer 904. In one implementation, the IMU 914 may be configured as a three-axis or three-degree of freedom (3DOF) position sensor system. This example position sensor system may, for example, include three gyroscopes to indicate or measure a change in orientation of the virtual-reality computing system 900 within 3D space about three orthogonal axes (e.g., roil, pitch, and yaw).

In another example, the IMU 914 may be configured as a six-axis or six-degree of freedom (6DOF) position sensor system. Such a configuration may include three accelerometers and three gyroscopes to indicate or measure a change in location of the virtual-reality computing system 900 along three orthogonal spatial axes (e.g., x, y, and z) and a change in device orientation about three orthogonal rotation axes (e.g., yaw, pitch, and roll). In some implementations, position and orientation data from the outward facing image sensors 912A, 912B and the IMU 914 may be used in conjunction to determine a position ad orientation (or 6DOF pose) of the virtual-reality computing system 900.

The virtual-reality computing system 900 may also support other suitable positioning techniques, such as GPS or other global navigation system then while specific examples of position sensor systems have been described, it will be appreciated that any other suitable sensor systems may be used. For example, head pose and/or movement data may be determined based on sensor information from any combination of sensors mounted on the wearer and/or external to the wearer including, but not limited to, any number of gyroscopes, accelerometers, inertial measurement units, GPS devices, barometers, magnetometers, cameras (e.g., visible light cameras, infrared light cameras, time-of-flight depth cameras, structured light depth cameras, etc.), communication devices (e.g., WIFI antennas/interfaces., etc.

The one or more microphones 916 may be configured to measure sound in the physical space. Data from the one or more microphones 916 may be used by the on-board computer 904 to recognize voice commands provided by the wearer to control the virtual-reality computing system 900.

The on-board computer 904 may include a logic machine and a storage machine, discussed in more detail below with respect to FIG. 9, in communication with the near-eye display 902 and the various sensors of the virtual-reality computing system 900.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, virtual reality computing devices, mobile computing devices, mobile communication devices (e.g., smart phone), and/or other computing devices.

Computing system 1000 includes a logic machine 1002 and a storage machine 1004. Computing system 1000 may optionally include a display subsystem 1006, input subsystem 1008, communication subsystem 1010, and/or other components not shown in FIG. 10.

Logic machine 1002 includes one or more physical devices configured to execute instructions. For example, the logic machine may be configured to execute instructions that are part of one or more applications services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1004 includes one or more physical devices configured to hold instructions executable by the logic machine to implement the methods and processes described herein. When such methods and processes are implemented, the state of storage machine 1004 may be transformed—e.g., to hold different data.

Storage machine 1004 may include removable and/or built-in devices. Storage machine 1004 may include optical memory (e.g., CD, DVD, HD-DVD, Blu-Ray Disc, etc), semiconductor memory (e.g., RAM, EPROM, EEPROM, etc), and/or magnetic memory (e.g., hard-disk drive, floppy-disk drive, tape drive, MRAM, etc), among others. Storage machine 1004 may include volatile, nonvolatile, dynamic, static, read/write, read-only, random-access, sequential-access, location-addressable, file-addressable, and/or content-addressable devices.

It will be appreciated that storage machine 1004 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1002 and storage machine 1004 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,”and “engine” may be used to describe an aspect of computing system 1000 implemented to perform a particular function. In some cases, a module, program, or engine may be instantiated via logic machine 1002 executing instructions held by storage machine 1004. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1006 may be used to present a visual representation of data held by storage machine 1004. This visual representation may take the form of a graphical user interface (GUI). As the herein described methods and processes change the data held by the storage machine, and thus transform the state of the storage machine, the state of display subsystem 1006 may likewise be transformed to visually represent changes in the underlying data. Display subsystem 1006 may include one or more display devices utilizing virtually any type of technology. For example, display subsystem 1006 may take the form of a near-eye display usable to present virtual imagery as part of an augmented/virtual reality environment. Such display devices may be combined with logic machine 1002 and/or storage machine 1004 in a shared enclosure, or such display devices may be peripheral display devices.

When included, input subsystem 1008 may comprise or interface with one or more user-input devices such as a keyboard, mouse, touch screen, or game controller. In some embodiments, the input subsystem may comprise or interface with selected natural user input (NUI) componetry. Such componetry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1010 may be configured to communicatively couple computing system 1000 with one or more other computing devices. Communication subsystem 1010 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

In an example, a method for moving a virtual object comprises: detecting a position of each of two input objects; dynamically calculating a position of a centroid that is equidistant from each of the two input objects and located between the two input objects, such that a reference line running between the two input objects intersects the centroid; and upon detecting a movement of the two input objects, translating the movement into a change in one or both of a position and an orientation of the virtual object, where: movement of the centroid caused by the movement of the two input objects causes movement of the virtual object in a direction corresponding to the movement of the centroid; and rotation of the reference line about the centroid caused by the movement of the two input objects causes rotation of the virtual object about its center in a direction corresponding to the rotation of the reference line. In this example or any other example, a change in distance between the centroid and the two input objects caused by the movement of the two input objects causes resizing of the virtual object. In this example or any other example, an increase in distance between the two input objects and the centroid along a horizontal axis causes an increase in size of the virtual object along the horizontal axis, and an increase in distance between the two input objects and the centroid along a vertical axis perpendicular to the horizontal axis causes an increase in size of the virtual object along the vertical axis. In this example or any other example, the movement of the two input objects causes a change in the position, the orientation, and the size of the virtual object. In this example or any other example, prior to changing one or both of the position and the orientation of the virtual object, the method further comprises receiving a targeting user input to target the virtual object for movement. In this example or any other example, one or both of the position and the orientation of the virtual object are only changed upon the movement of the two input objects exceeding a threshold distance. In this example or a other example, the two input objects are hands of a user. In this example or any other example, the detected movement is translated into a change in one or both of the position and the orientation of the virtual object by a machine learning classifier. In this example or any other example, translation of the detected movement by the machine learning classifier s based on a current position frame d a plurality of previously recorded position frames corresponding to previous positions of the two input objects, and each position frame specifies, for a time at which the position frame was recorded, a position of the centroid, an angle of the reference line, and a distance between the centroid and the two input objects. In this example or any other example, translation of the detected movement by the machine learning classifier is also based on a current state of a running software application. In this example or any other example, translation of the detected movement by the machine learning classifier is also based on changes in one or more of a position, orientation, and size previously applied to or more other virtual objects.

In an example, a computing device comprises: a logic machine; and a storage machine holding instructions executable by the logic machine to: detect a position of each of two input objects; dynamically calculate a position of a centroid that is equidistant from each of the two input objects and located between the two input objects, such that a reference line, running between the two input objects intersects the centroid; and upon detecting a movement of the two input objects, translate the movers movement into a change in one or both of a position and an orientation of virtual object presented via a display, where: movement of the centroid caused by the movement of the two input objects causes movement of the virtual object in a direction corresponding to the movement of the centroid; and rotation of the reference line about the centroid caused by the movement of the two input objects causes rotation of the virtual object about its center in a direction corresponding to the orientation of the reference line. In this example or any other example, the movement of the two input objects causes a change in the position, the orientation, and a size of the virtual object. In this example or any other example, an increase in distance between the two input objects and the centroid along a horizontal axis causes an increase in size of the virtual object along the horizontal axis, and an increase in distance between the two input objects and the centroid along a vertical axis perpendicular to the horizontal axis causes an increase in size of the virtual object along the vertical axis. In this example or any other example, prior to changing one or both of the position and the orientation of the virtual object, the method further comprises receiving a targeting user input to target the virtual object for movement. In this example or any other example, the two input objects are hands of a user. In this example or any other example, translation of the detected movements done by a machine learning classifier and based on a current position frame and a plurality of previously recorded position frames corresponding to previous positions of the two input objects, and each position frame specifies, for a time at which the position frame was recorded, a position of the centroid, an angle of the reference line, and a distance between the centroid and the two input objects. In this example or any other example, translation of the detected movement by the machine learning classifier is also based on a current state of a running software application. In this example or any other example, translation of the detected movement by the machine learning classifier is also based on changes in one or more of a position, orientation, and size previously applied to one or more other virtual objects.

In an example, a method for moving a virtual object comprises: detecting a position of each of two hands of a user; dynamically calculating a position of a centroid that is equidistant from each of the two hands and located between the two hands, such that a reference line running between the two hands intersects the centroid; and upon detecting a movement of the two hands, translating the movement into a change in a position, an orientation, and a size of the virtual object, where: movement of the centroid caused by the movement of the two hands causes movement of the virtual object in a direction corresponding to the movement of the centroid; rotation of the reference line about the centroid caused by the movement of the two hands causes rotation of the virtual object about its center in a direction corresponding to the rotation of the reference line; and a change in distance between the centroid and the two input objects caused by the movement of the two input objects causes resizing of the virtual object.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for moving a virtual object, comprising:
detecting a position of each of two input objects;
dynamically calculating a position of a centroid that equidistant from each of the two input objects and located between the two input objects, such that a reference line running between the two input objects intersects the centroid; and
upon detecting a movement of the two input objects, translating the movement into a change in one or both of a position and an orientation of the virtual object, where:
movement of the centroid caused by the movement of the two input objects causes movement of the virtual object in a direction corresponding to the movement of the centroid; and
rotation of the reference line about the centroid caused by the movement of the two input objects causes rotation of the virtual object about its center in a direction corresponding to the rotation of the reference line.

2. The method of claim 1, where a change in distance between the centroid and the two input objects caused by the movement of the two input objects causes resizing of the virtual object.

3. The method of claim 2, where an increase in distance between the two input objects and the centroid along a horizontal axis causes an increase in size of the virtual object along the horizontal axis, and an increase in distance between the two input objects and the centroid along a vertical axis perpendicular to the horizontal axis causes an increase in size of the virtual object along the vertical axis.

4. The method of claim 2, where the movement of the two input objects causes a change in the position, the orientation, and a size of the virtual object.

5. The method of claim where prior to changing one or both of the position and the orientation of the virtual object, the method further comprises receiving a targeting user input to target the virtual object for movement.

6. The method of claim 1, where one or both of the position and the orientation of the virtual object are only changed upon the movement of the two input objects exceeding a threshold distance.

7. The method of claim 1 where the two input objects are hands of a user.

8. The method of claim 1, where the detected movement is translated into a change in one or both of the position and the orientation of the virtual object by a machine learning classifier.

9. The method of claim 8, where translation of the detected movement by the machine learning classifier is based on a current position frame and a plurality of previously recorded position frames corresponding to previous of the two input objects, where each position frame specifies, for a time at which the position frame was recorded, a position of the centroid, an angle of the reference line, and a distance between the centroid and the two input objects.

10. The method of claim 8, where translation of the detected movement by the machine learning classifier is also based on a current state of a running software application.

11. The method of claim 8, where translation of the detected movement by the machine learning classifier is also based on changes in one or more of a position, orientation, and size previously applied to one or more other virtual objects.

12. A computing device, comprising:
a logic machine; and
a storage machine holding instructions executable by the logic machine to:
detect a position of each of two input objects;
dynamically calculate a position of a centroid that is equidistant from each of the two input objects and located between the two input objects, such that a reference line running between the two input objects intersects the centroid; and
upon detecting a movement of two input objects, translate the movement into a change in one or both of a position and an orientation of a virtual object presented via a display, where:
movement of the centroid caused by the movement of the two input objects causes movement of the virtual object in a direction corresponding to the movement of the centroid; and
rotation of the reference line about the centroid caused by the movement of the two input objects causes rotation of the virtual object about its center in a direction corresponding to the rotation of the reference line.

13. The computing system of claim 12, where the movement of the two input objects causes a change in the position, the orientation, and a size of the virtual object.

14. The computing system of claim 13, where an increase in distance between the two input objects and the centroid along a horizontal axis causes an increase in size of the virtual object along the horizontal axis, and an crease in distance between the two input objects and the centroid along a vertical axis perpendicular to the horizontal axis causes an increase in size of the virtual object along the vertical axis.

15. The computing system of claim 12, where prior to changing one or both of the position and the orientation of the virtual object, the method further comprises receiving a targeting user input to target the virtual object for movement.

16. The computing system of claim where two input objects are hands of a user.

17. The computing system of claim 12, where translation of the detected movement is done by a machine learning classifier and based on a current position frame and a plurality of previously recorded position frames corresponding to previous positions of the two input objects, where each position frame specifies, for a time at which the position frame was recorded, a position of the centroid, an angle of the reference line, and a distance between the centroid and the two input objects.

18. The computing system of 17, where trans of the detected movement by the machine learning classifier is also based on a current state of a running software application.

19. The computing system of claim 17, where translation of the detected movement by the machine learning classifier is also based on changes in one or more of a position, orientation, and size previously applied to one or more other virtual objects.

20. A method for moving a virtual object, comprising:
detecting a position of each of two hands of a user;
dynamically calculating a position of a centroid that is equidistant from each of the two hands and located between the two hands, such that a reference line running between the two hands intersects the centroid; and
upon detecting a movement of the two hands, translating the movement into a change in a position, an orientation, and a size of the virtual object, where:
movement of the centroid caused by the movement of the two hands causes movement of the virtual object in a direction corresponding to the movement of the centroid;
rotation of the reference line about the centroid caused by the movement of the two hands causes rotation of the virtual object about its center a direction corresponding to the rotation of the reference line; and
a change in distance between the centroid the two input objects caused by the movement of the two input objects causes resizing of the virtual object.
